(19) United States
(12) Patent Application Publication
(10) Pub. No.: US 2015/0229786 A1
(43) Pub. Date: Aug. 13, 2015

(54) COMMUNICATION DEVICE AND CONTROL METHOD OF COMMUNICATION DEVICE

(71) Applicant: CANON KABUSHIKI KAISHA, Tokyo (JP)

(72) Inventor: Shunji Fujita, Kawasaki-shi (JP)

(21) Appl. No.: 14/615,330

(22) Filed: Feb. 5, 2015

(30) Foreign Application Priority Data
Feb. 7, 2014 (JP) 2014-022555

(51) Int. Cl. H04N 1/00; H04N 1/21; H04N 5/232

(52) U.S. Cl. CPC H04N 1/00209; H04N 5/232; H04N 1/2112

(57) ABSTRACT

A communication device includes an image pickup unit, a connection unit connected to an external device, a transmission unit including a first function for transmitting an image data recorded in a recording medium to the external device, and a second function for successively transmitting an image data captured by the image pickup unit to the external device, and an output unit configured to output image data, as a candidate of image data to be transmitted by the first function, chosen from among the recorded image data, based on information about a subject captured by the image pickup unit and information about the external device, in a case where an instruction for executing the first function is received while the transmission unit is executing the second function.

### BACKGROUND OF THE INVENTION

1. Field of the Invention

The present invention relates to a communication device and a control method of the communication device, and more particularly, a technique for use with a communication device that performs streaming via a network.

2. Description of the Related Art

In recent years, a technique for performing streaming via a network has been suggested. For example, HTTP Live Streaming draft-pantos-http-live-streaming-08 (Apple Inc. Mar. 23, 2012 (https://tools.ietf.org/html/draft-pantos-http-live-streaming-08)) defines a technique for achieving real-time streaming using HTTP protocol. By implementing a streaming function in a digital camera, real-time streaming can be realized. For example, video captured by a camera and video obtained by playing a motion picture recorded in a recording medium provided in a camera can be displayed in real-time by a display device such as a television set, a PC, a tablet, and the like connected via a network.

In this case, a camcorder having the streaming function explained above may be used in the following scenes, for example. More specifically, when video of a child taken by a person (father) is shown in real-time to grandparents who lives at a distance, not only the video currently shot but also motion pictures of the child recorded in the past are the scenes which are desired to be shown to the grandparents.

However, under the present situation, in order to achieve that, the camcorder is to be switched to a playback mode (motion picture selection screen) and find a desired motion picture from among all the motion pictures recorded in the camcorder, which is troublesome for the person who takes videos.

### SUMMARY OF THE INVENTION

A communication device according to the present invention includes an image pickup unit; a recording unit configured to record image data captured by the image pickup unit to a recording medium; a connection unit connected to an external device; a transmission unit including a first function for transmitting the recorded image data to the external device, and a second function for successively transmitting the image data captured by the image pickup unit to the external device; and an output unit configured to output image data, as a candidate of image data to be transmitted by the first function, chosen from among the recorded image data, based on information about a subject captured by the image pickup unit and information about the external device, in a case where an instruction for executing the first function is received while the transmission unit is executing the second function.

Further features of the present invention will become apparent from the following description of exemplary embodiments (with reference to the attached drawings).

### BRIEF DESCRIPTION OF THE DRAWINGS

FIG. 1 is a figure illustrating an example of an internal configuration of a camera according to an embodiment of the present invention.

FIG. 2 is a figure illustrating an example of an internal configuration of a PC according to an embodiment of the present invention.

FIG. 3 is a figure illustrating an example of a flow of processing of video analysis according to an embodiment of the present invention.

FIG. 4 is a figure illustrating an example of analysis data according to an embodiment of the present invention.

FIGS. 5A and 5B are figures illustrating an example of a content database according to an embodiment of the present invention.

FIG. 6 is a figure illustrating an example of a network configuration according to an embodiment of the present invention.

FIG. 7 is a figure illustrating an operation mode of a camera according to an embodiment of the present invention.

FIG. 8 is a flowchart illustrating shooting streaming processing according to an embodiment of the present invention.

FIG. 9 is a flowchart illustrating playback streaming processing according to a first embodiment of the present invention.

FIGS. 10A to 10C are figures illustrating an example of a flow of processing for generating a search key according to an embodiment of the present invention.

FIGS. 11A to 11C are figures illustrating an example of a motion picture selection screen according to an embodiment of the present invention.

FIG. 12 is a flowchart illustrating playback streaming processing according to a second embodiment of the present invention.

FIG. 13 is a flowchart illustrating playback streaming processing according to a third embodiment of the present invention.

FIG. 14 is a flowchart illustrating playback streaming processing according to a fourth embodiment of the present invention.

FIG. 15 is a flowchart illustrating playback streaming processing according to a fifth embodiment of the present invention.

### DESCRIPTION OF THE EMBODIMENTS

An embodiment of the present invention will be hereinafter explained in details with reference to appended drawings.

### First Embodiment

A first embodiment of the present invention will be hereinafter explained with reference to the drawings.

<Configuration of Camera>

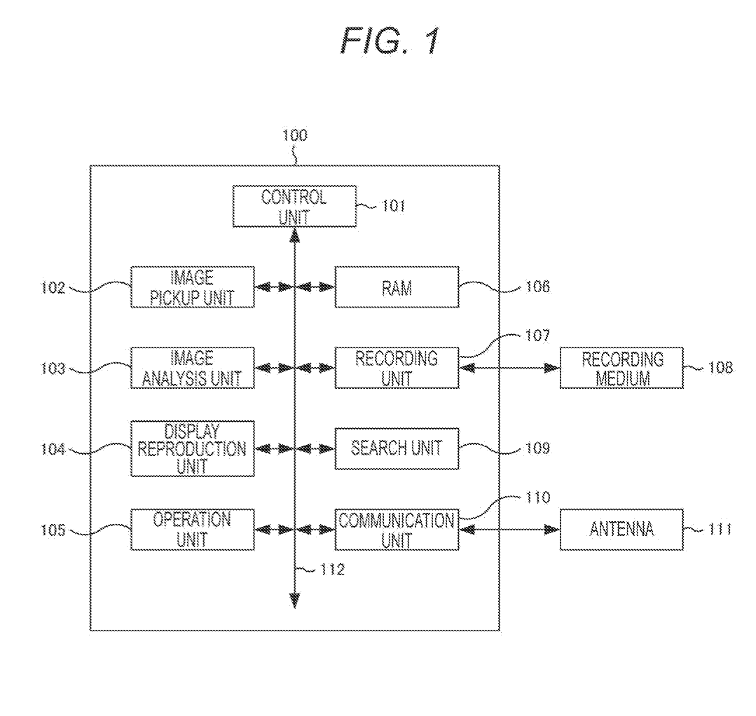

FIG. 1 is a block diagram illustrating a configuration of a camera 100 according to the first embodiment of the present invention. A camera 100 represents an example of a communication device according to the present invention. The camera 100 according to the present embodiment includes a shooting mode in which shooting is performed by a shooting unit and a playback mode in which playback executed exclusively from the shooting mode is performed.

In FIG. 1, Reference numeral 101 denotes a control unit, and corresponds to control means according to the present invention. The control unit 101 is constituted by, for example, a CPU, and extracts a program stored in ROM (not shown) to RAM 106 and executes the program to control all the processing blocks constituting the camera 100. Alternatively, the control performed by the control unit 101 may be executed in a distributed manner by multiple sets of hardware instead of being executed by the control unit 101 alone.

Reference numeral 102 denotes an image pickup unit, and corresponds to shooting means according to the present invention. The image pickup unit generates captured video data (captured image). The image pickup unit 102 includes an optical lens, a CMOS sensor, a digital image processing unit, and the like, and is a processing block for converting an analog signal received via an optical lens into digital data, and obtaining a captured image. The image pickup unit 102 transmits the obtained captured image to the image analysis unit 103, and encodes the captured image into a predetermined motion picture format, and stores the captured image to the RAM 106. The stored captured image is processed by the control unit 101. The image pickup unit 102 also includes a lens control unit, and controls zoom, focus, aperture adjustment, and the like, on the basis of a command given by the control unit 101.

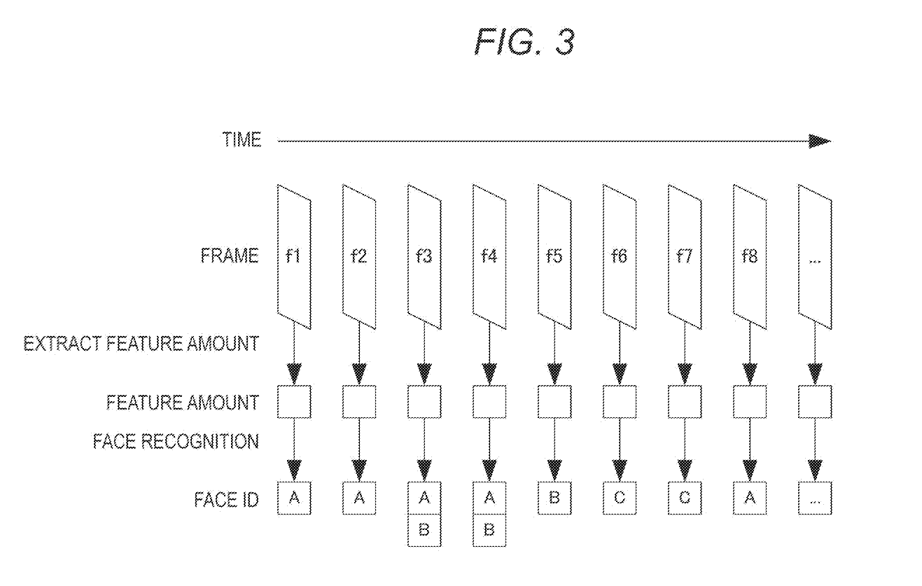

Reference numeral 103 denotes image analysis unit. On the basis of an instruction given by the control unit 101, the image analysis unit 103 analyzes a captured image transmitted from the image pickup unit 102, and accumulates the analysis result to the RAM 106 as analysis information. FIG. 3 illustrates an example of a flow of processing. The image analysis unit 103 extracts a feature amount for each frame image of the captured image, and executes face detection processing on the extracted feature amount. When a face is detected, subsequently, collation processing is executed on a face information database, so that a related face ID is obtained. The image analysis unit corresponds to video analysis means according to the present invention.

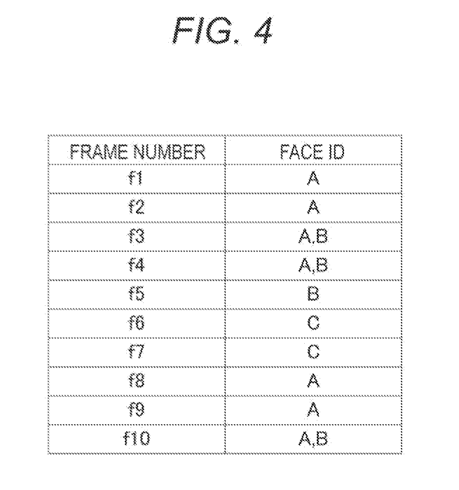

The face information database is a database in which an association between a face ID and a feature amount is registered, and in the present embodiment, the camera 100 is provided with the face information database in advance. For example, the face information database is recorded to nonvolatile memory, not shown, provided in the camera 100. When multiple faces are included in the frame image, multiple face IDs are obtained from the face information database. The image analysis unit 103 stores information about the face ID obtained from the face information database to a predetermined area on the RAM 106 in association with a frame number (hereinafter the above information will be referred to as analysis data). FIG. 4 illustrates an example of stored analysis data. FIG. 3 shows an example of executing feature amount extraction on each frame as a unit. Alternatively, in order to reduce the processing load, the feature amount extraction may be executed on multiple frames at a time.

Reference numeral 104 denotes a display reproduction unit, and corresponds to display reproduction means according to the present invention. The display reproduction unit 104 is constituted by a liquid crystal panel or an organic EL panel, and displays various kinds of information data on the basis of an instruction of the control unit 101. In this case, various kinds of information data mean captured image obtained by the image pickup unit 102, motion picture data which are read by the recording unit 107 from the recording medium 108, operation screen data, or the like.

Reference numeral 105 denotes an operation unit. The operation unit 105 is constituted by a button, a dial, a touch panel, and the like, and receives user's operation instruction. Operation information which is input with the operation unit 105 is transmitted to the control unit 101, and the control unit 101 executes control of each processing block on the basis of contents of the operation information. The operation unit 105 corresponds to reception means according to the present invention.

Reference numeral 106 denotes RAM, and is a memory used as a work area for the control unit 101 and a temporary buffer area of various kinds of data.

Reference numeral 107 denotes a recording unit, is an interface for connection with a large capacity recording medium 108 to exchange data. On the basis of an instruction of the control unit 101, the recording unit stores various kinds of data to the recording medium 108, and reads various kinds of data from the recording medium 108.

Reference numeral 108 denotes a recording medium, and is constituted by, for example, an internal flash memory, an internal hard disk, a detachable memory card, or the like.

Reference numeral 109 denotes a search unit. On the basis of an instruction given by the control unit 101, the search unit 109 executes search processing on a content database stored in the recording medium 108, and obtains identifier information of video data as well as correlation degree information of correlation with search key information. The search unit 109 corresponds to search means according to the present invention. Hereinafter, the content database, the identifier information of the video data, the search key information, and the correlation degree information will be explained.

The content database is a database for storing meta-information of content stored in the recording medium 108, and is generated in shooting recording processing.

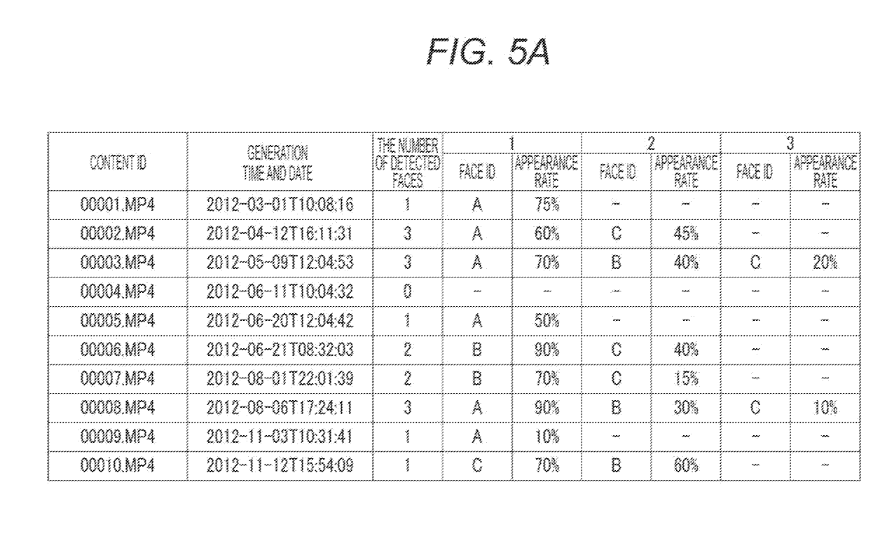

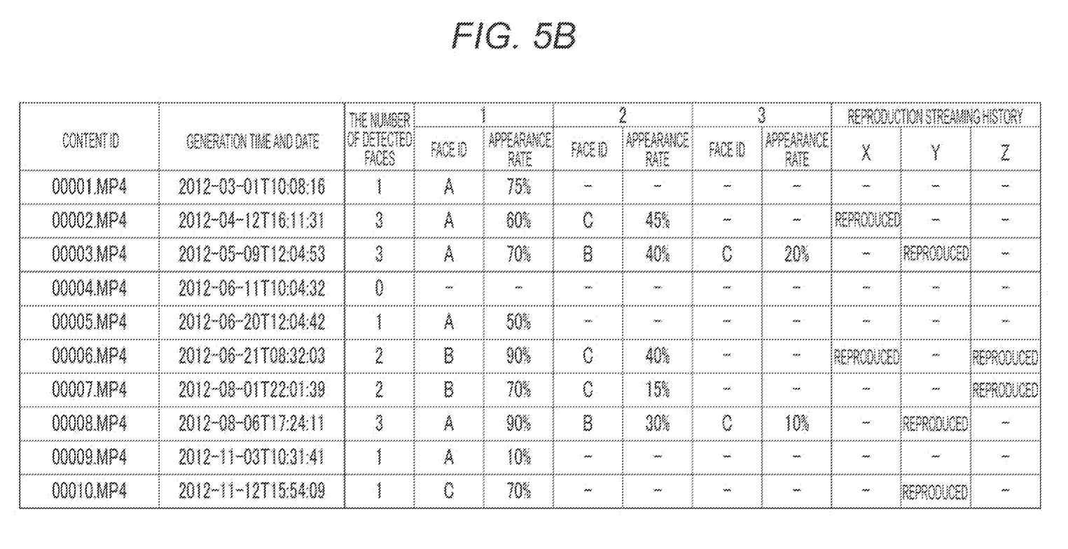

In this case, FIG. 5A illustrates an example of a content database.

As can be seen in FIG. 5A, the content database stores content ID, generation date and time, face detection number, and face detection information. For example, the identifier information of the video data is, for example, the content ID of FIG. 5A. The face detection information in FIG. 5A is information about a face ID and an appearance rate, and is generated on the basis of an analysis result of the image analysis unit 103 explained above. The appearance rate indicates a ratio of the detected number of frames with respect to all of the frames, and corresponds to the correlation degree information.

Content of which content ID is “00003.MP4” shown in FIG. 5A corresponds to content of which analysis result is shown in FIG. 4. The search unit 109 executes search processing on the content database as shown in FIG. 5A using a face ID as a search key, and obtains the corresponding content ID and the corresponding appearance rate information as a search result. In some cases, there may be multiple search results.

FIG. 1 will be hereinafter explained again.

Reference numeral 110 denotes a communication unit, and corresponds to communication means according to the present invention. The communication unit 110 includes an antenna 111 for wireless LAN, and is a processing block for performing wireless LAN communication according to, for example IEEE802.11n method. The communication unit 110 connects to an external access point via wireless LAN, and performs wireless LAN communication with a PC 200 via the access point, and transmits and receives data to/from the external device.

Reference numeral 112 denotes an internal bus. The internal bus 112 is a bus for connecting processing blocks with each other in the camera 100.

An internal configuration of the camera 100 has been hereinabove explained.

Subsequently, a shooting streaming function and a playback streaming function provided in the camera 100 will be explained.

The shooting streaming function is a function for causing the communication unit 110 to output a captured image received from the image pickup unit 102, and transmit the captured image in real-time to an external device connected to the network. During execution of shooting streaming, the analysis processing performed by the image analysis unit 103 is executed on a captured image received from the image pickup unit 102, and a recognition result list which is an analysis result, is stored to the RAM 106 in a buffering format. The shooting streaming function corresponds to shooting streaming transmission means according to the present invention, and transmits captured video data to a designated external device in real-time as a streaming.

The playback streaming function is a function for causing the communication unit 110 to output motion picture data which have been read out from the recording medium 108 and played back by the display reproduction unit 104, and transmit the motion picture data to an external device connected to a network in real-time. The playback streaming function corresponds to playback streaming transmission means according to the present invention, and transmits video data, which have been read out from a recording medium, to a designated external function in real-time as a streaming.

<Configuration of PC>

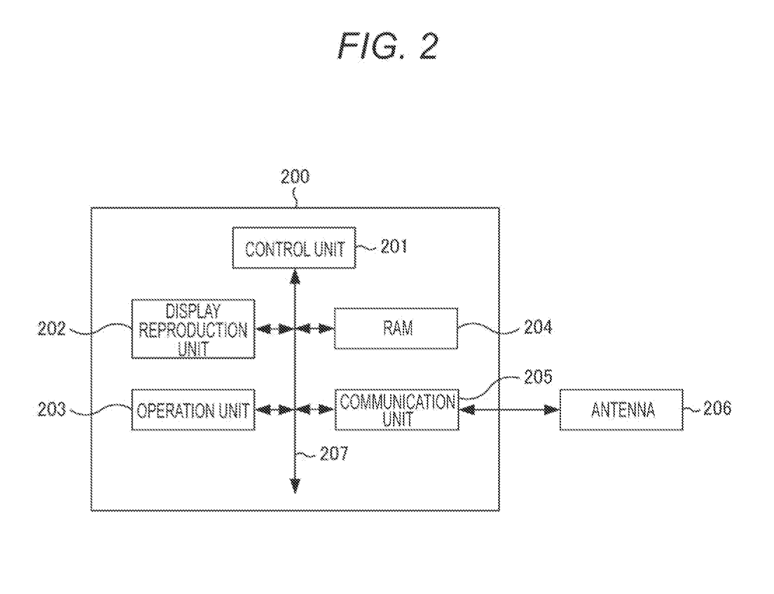

FIG. 2 is a block diagram illustrating a configuration of a PC 200 according to the first embodiment. For example, the PC 200 represents an external device according to the present invention.

Reference numeral 201 denotes a control unit. For example, the control unit 201 is constituted by a CPU, and controls all the processing blocks (entire device) constituting the PC 200.

Reference numeral 202 denotes a display reproduction unit. The display reproduction unit 202 is constituted by a liquid crystal display and the like, and displays various kinds of information data on a display screen on the basis of an instruction of the control unit 201. The display reproduction unit 202 executes display of streaming image data transmitted from the camera 100.

Reference numeral 203 denotes an operation unit. The operation unit 203 is constituted by buttons, an arrow key, a touch panel, a remote controller, or the like, and receives an operation instruction from a user. The operation information received from the operation unit 203 is transmitted to the control unit 201, the control unit 201 executes control of each processing block on the basis of the operation information.

Reference numeral 204 denotes RAM. The RAM 204 is used as a work area of the control unit 201, a temporary buffer area for video data received from the outside, and the like.

Reference numeral 205 denotes a communication unit. The communication unit 205 includes an antenna 206 for wireless LAN, and is a processing block for performing wireless LAN communication according to, for example IEEE802.11n method. The communication unit 205 connects to an external access point via wireless LAN, and performs wireless LAN communication with the camera 100 via the access point.

Reference numeral 207 denotes an internal bus. The internal bus 207 is a bus for connecting the processing blocks with each other in the PC 200.

The internal configuration of the PC 200 has been hereinabove explained.

<Network Configuration>

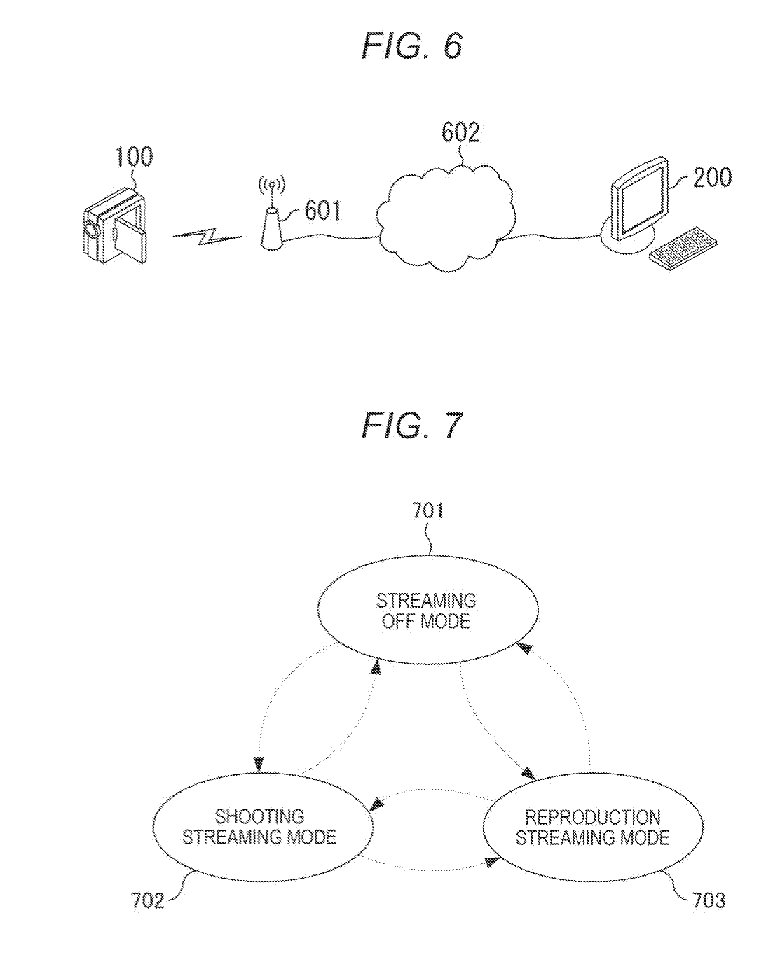

FIG. 6 is a figure illustrating a network configuration according to the present embodiment.

Reference numerals 100, 200 denote the camera 100 and the PC 200 explained above. Reference numeral 601 denotes a wireless LAN access point. Reference numeral 602 denotes an Internet network.

The camera 100 is connected via the wireless LAN access point 601 to the Internet network 602, and connected via the Internet network 602 to the PC 200. In the present embodiment, the camera 100 is considered to have already established an IP network connection with the PC 200, and the explanation about connection establishing procedure is not the gist of the present invention, and is therefore omitted.

<Operation Mode>

FIG. 7 is a figure illustrating an operation mode of the camera 100.

In FIG. 7, reference numeral 701 denotes a streaming OFF mode indicating a state in which neither shooting streaming transmission nor playback streaming transmission is performed. For example, this corresponds to a state in which the camera 100 is turned OFF or a state in which the camera 100 is turned ON and the function of the communication unit 110 is invalidated.

Reference numeral 702 denotes the shooting streaming mode indicating the state in which the shooting streaming function is executed.

Reference numeral 703 denotes the playback streaming mode indicating the state in which the playback streaming function is executed.

It should be noted that the mode can be switched between the operation modes, and the mode is switched according to user operation with the operation unit 105.

<Shooting Streaming Mode Processing Flow>

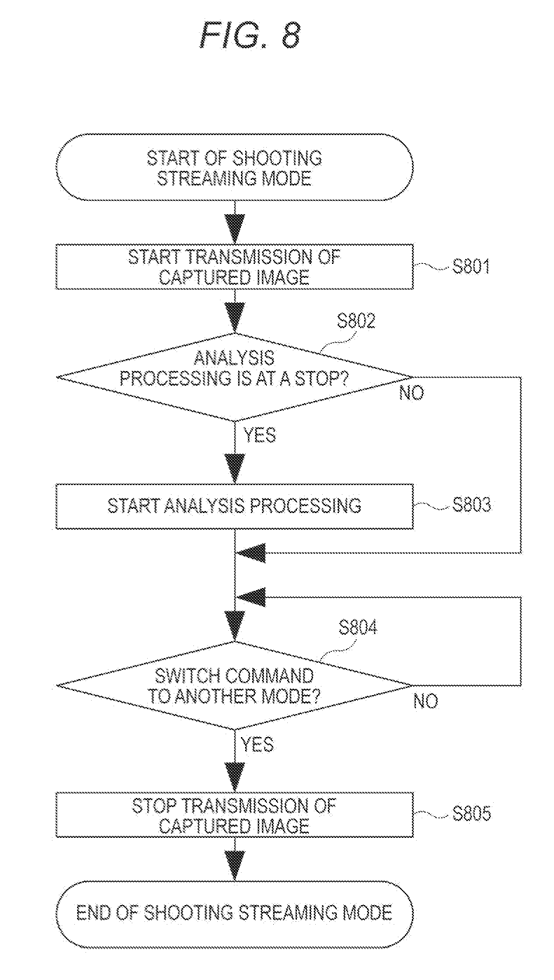

Subsequently, the details of the processing in the shooting streaming mode of the camera 100 will be explained with reference to FIG. 8. This processing is started when a switching instruction for switching from the streaming OFF mode or the playback streaming mode to the shooting streaming mode is given with the operation unit 105.

In step S801, the control unit 101 controls the entire device including the image pickup unit 102 and the communication unit 110, and starts streaming transmission of a captured image to the PC 200. As a result of this processing, the PC 200 uses the communication unit 205 to receive the streaming image, and displays the image on the display reproduction unit 104. In the present embodiment, the explanation about connection establishing procedure for establishing connection between the camera 100 and the PC 200 which is a premise is not the gist of the present invention, and is therefore omitted.

In step S802, the control unit 101 determines whether the analysis processing performed by the image analysis unit 103 is at a stop or not. When the control unit 101 determines that the analysis processing is at a stop, subsequently step S803 is performed. When the control unit 101 determines that the analysis processing is not at a stop, subsequently step S804 is performed.

In step S803, the control unit 101 controls the image analysis unit 103 and starts the analysis processing. In this step, the image analysis unit 103 starts analysis of the captured image received from the image pickup unit 102, and the analysis data are stored to a predetermined area of the RAM 106.

In step S804, the control unit 101 determines whether a switching instruction to another operation mode is executed with the operation unit 105, and when the control unit 101 determines that the switching instruction is executed, subsequently step S805 is performed. When the control unit 101 determines that the switching instruction is not executed, the control unit 101 waits.

In step S805, the control unit 101 controls the image pickup unit 102 to stop the streaming transmission of the captured image to the PC 200, and terminates the shooting streaming mode.

<Playback Streaming Mode Processing Flow>

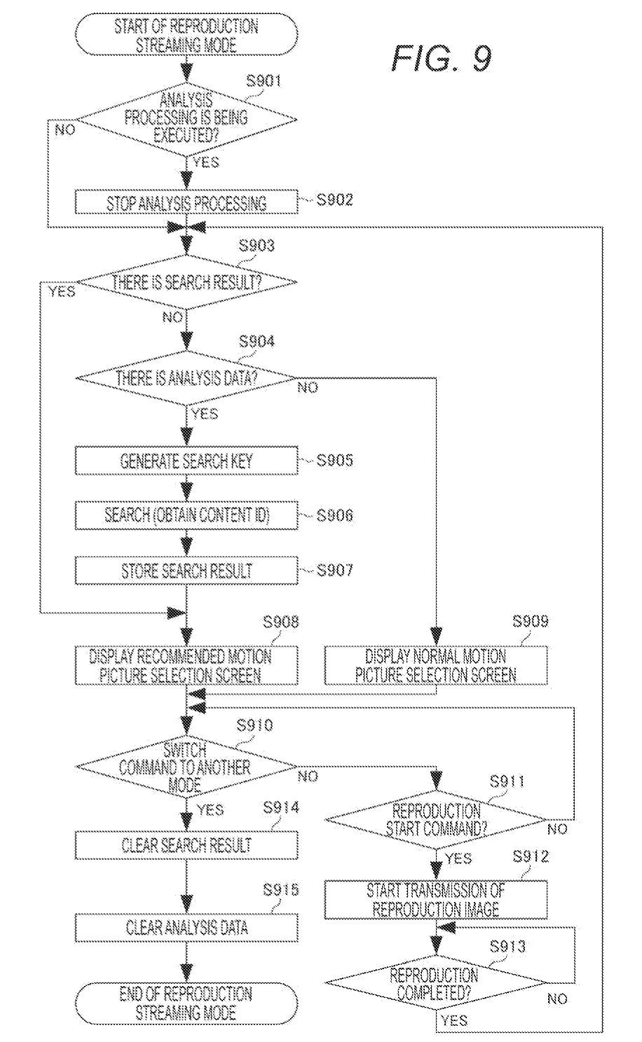

Subsequently, the details of the processing in the playback streaming mode of the camera 100 will be explained with reference to FIG. 9. This processing is started in a case where a switching instruction from the streaming OFF mode or the shooting streaming mode to the playback streaming mode is performed with the operation unit 105.

In step S901, the control unit 101 determines whether the analysis processing performed by the image analysis unit 103 is being executed or not. When the control unit 101 determines that the analysis processing is being executed, subsequently step S902 is performed. When the control unit 101 determines that the analysis processing is not being executed, subsequently step S903 is performed.

In step S902, the control unit 101 controls the image analysis unit 103, and stops the analysis processing. In this step, the image analysis unit 103 stops the analysis of the captured image received from the image pickup unit 102, and in addition, the processing for storing the analysis data to a predetermined area on the RAM 106 is also stopped.

In step S903, the control unit 101 determines whether a search processing result produced by the search unit 109 is stored to the predetermined area on the RAM 106 or not. When the control unit 101 determines that the search processing result is stored there, subsequently step S908 is performed. When the control unit 101 determines that the search processing result is not stored there, subsequently step S904 is performed. It should be noted that the search processing performed by the search unit 109 and the processing for storing the search result to the predetermined area on the RAM 106 correspond to processing in step S906 and step S907 explained later. For this reason, when this flowchart is first executed, this step is determined to be “NO”.

In step S904, the control unit 101 determines whether the analysis data obtained by the image analysis unit 103 is stored in a predetermined area on the RAM 106 or not. When the control unit 101 determines that the analysis data are stored, subsequently step S905 is performed. When the control unit 101 determines that the analysis data are not stored, subsequently step S909 is performed.

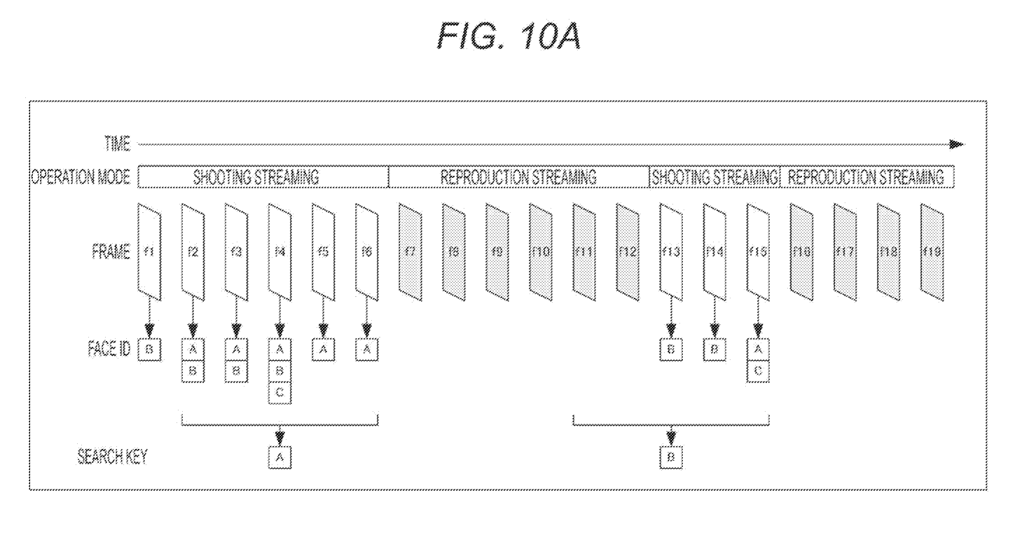

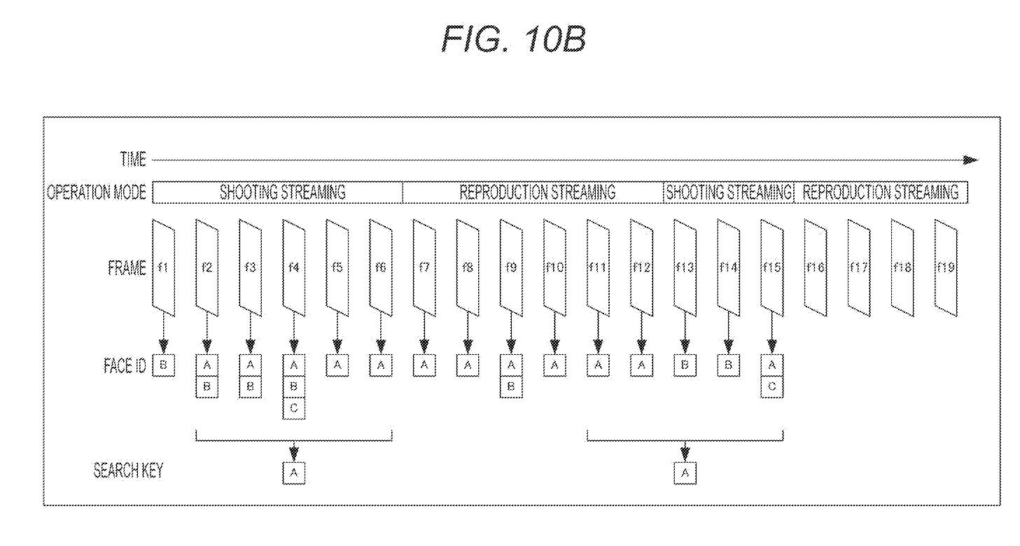

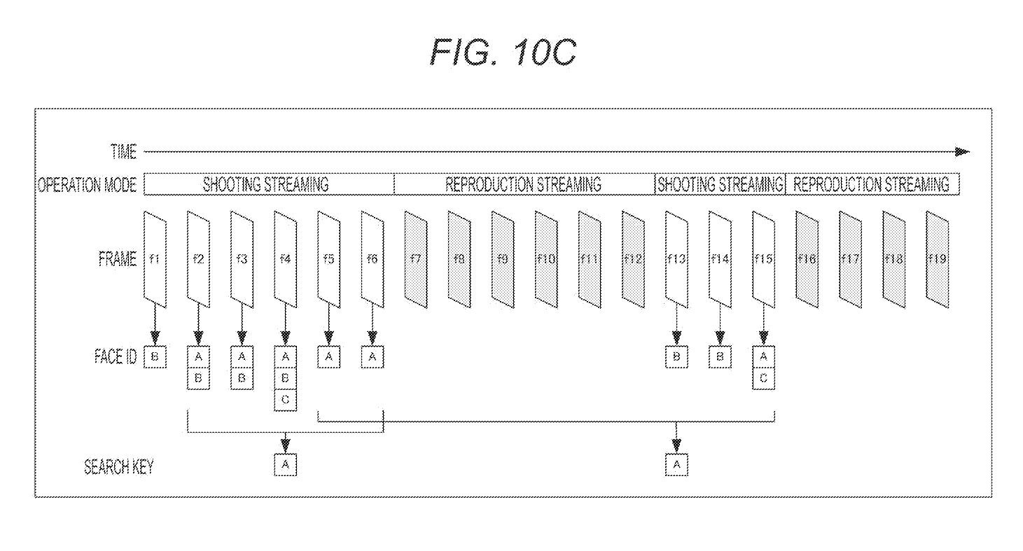

In step S905, the control unit 101 generates a search key for searching the content database from the analysis data. In this case, a flow of processing of this step will be explained with reference to FIG. 10A.

FIG. 10A is a figure illustrating, along a temporal axis, frame images transmitted to the network and a flow of determining a search key from frame images, and switching of the operation mode is executed at times of f6 to f7, f12 to f13, f15 to f16.

In the switching from the shooting streaming mode to the playback streaming mode, the generation processing for generating a search key in this step is executed. When a request for the playback streaming transmission is received when the shooting streaming transmission is performed, a search key is generated on the basis of analysis information analyzed by the image analysis unit since a predetermined period of time before receiving the instruction (a time when the shooting streaming transmission is started).

Then, the control unit 101 determines, as a search key, the face ID of the highest appearance frequency from among the face IDs included in the analysis data obtained from the five image frames immediately before. As shown in FIG. 10A, when the processing in this step is executed in the time from f6 to f7, the search key becomes A, and when the processing in this step is executed in the time from f15 to f16, the search key becomes B.

In f11, f12, the analysis processing performed by the image analysis unit 103 is not executed, and therefore, no analysis data exist. For this reason, when the processing in this step is executed at the time of f15, a search key is determined using only the analysis data obtained from f13 to f15.

In this step, the range of the image frames for which the search key is determined is five frames immediately before the time when the search processing is executed, but the range is not limited thereto. For example, the range may be a range between the time when the shooting streaming is started and the time when the search processing is executed.

In this step, the processing for determining that the face ID that appears most frequently is the search key is employed, but the criteria for determination is not limited thereto. Analysis data obtained from frames close to the time when the search processing is executed may be multiplied by a certain coefficient to be given weights and used as the criteria.

In this step, for the sake of convenience, the analysis processing is performed on each frame in this explanation, but this step is not limited thereto. The analysis processing may be performed on multiple number of frames as a unit.

In step S906, the control unit 101 controls the search unit 109, and executes searching of the content database. The search unit 109 executes search processing using the search key determined in step S905, and obtains a search result, the corresponding content ID and the appearance rate information.

For example, the result searched from the content database as shown in FIG. 5A using the search key A generated in the time from f6 to f7 in FIG. 10A is as follows:

### 00008.MP4 (90%), 00001.MP4 (75%), 00003.MP4 (70%), 00002.MP4 (60%), 00005.MP4 (50%), and 00009.MP4 (10%).

The result searched using the search key B generated in the time from f15 to f16 is as follows:

### 00006.MP4 (90%), 00007.MP4 (70%), 00010.MP4 (60%), 00003.MP4 (40%), and 00008.MP4 (30%).

In step S907, the control unit 101 stores the search result obtained in step S906 to a predetermined area on the RAM 106.

In step S908, the control unit 101 controls the recording unit 107 to extract content to the RAM 106 in the descending order of the correlation degree on the basis of the search result obtained in step S906, and controls the display reproduction unit 104 to display a motion picture selection screen.

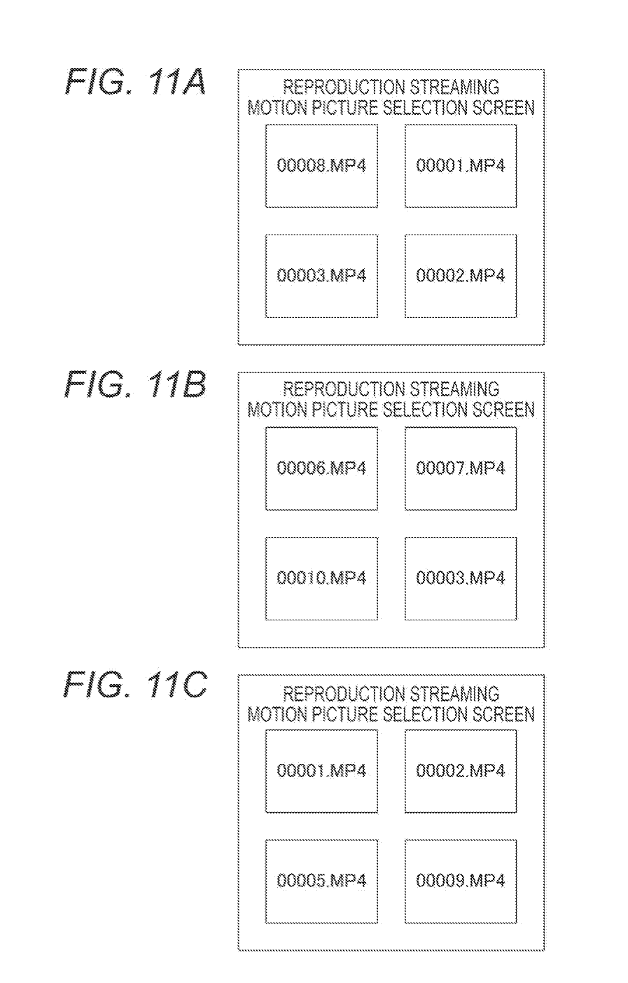

In this case, FIG. 11A illustrates a motion picture selection screen generated on the basis of the search result with the search key A generated in the time from f6 to f7 of FIG. 10A. FIG. 11B illustrates a motion picture selection screen generated on the basis of the search result with the search key B generated in the time from f15 to f16.

In step S909, the control unit 101 controls the recording unit 107 to read the content to the RAM 106 in the descending order of the date and time of recording to the recording unit 107, and controls the display reproduction unit 104 to display the motion picture selection screen. In this case, the displayed motion picture selection screen is a screen in which thumbnail images are shown in the following order: 00010.MP4 (2012-11-12T15: 54: 09), 00009.MP4 (2012-11-03T10: 31: 41), 00008.MP4 (2012-08-06T17: 24: 11), and 00007.MP4 (2012-08-01T22: 01: 39).

In step S910, the control unit 101 determines whether switching to an operation mode other than the playback streaming is instructed with the operation unit 105 or not. When the control unit 101 determines that the switching is instructed, subsequently step S914 is performed. When the control unit 101 determines that the switching is not instructed, subsequently step S911 is performed.

In step S911, the control unit 101 determines whether content is designated and a request for start of playback is given with the operation unit 105 or not. When the control unit 101 determines that it is requested, subsequently step S912 is performed. When the control unit 101 determines that it is not requested, subsequently step S910 is performed again.

In step S912, the control unit 101 controls the display reproduction unit 104, and executes the playback processing of the designated content, and starts streaming transmission of the playback image by controlling the communication unit 110.

In step S913, the control unit 101 determines whether the playback of the content executed in step S912 is finished or not. The finish of the content playback is determined according to whether the user executed termination with the operation unit 105, or whether the playback of the content to the end of the content is completed or not. When the control unit 101 determines that the playback of the content has been finished, subsequently step S903 is performed again.

In step S914, the control unit 101 erases the search result stored in the predetermined area on the RAM 106.

In step S915, the control unit 101 erases the analysis data stored in the predetermined area on the RAM 106, and executes transition to the mode designated in step S910, and terminates the playback streaming mode.

As described above, in the present embodiment, the processing in the playback streaming mode explained with reference to FIG. 9 is carried out. Accordingly, in a case where switching instruction from the shooting streaming mode to the playback streaming is given, the motion picture selection screen can be generated, in which recorded motion pictures related to the same subject as the subject of the shooting streaming are displayed with a higher degree of precedence on the basis of the analysis result of the captured video.

In the present embodiment, in step S901 and step S902, the analysis processing performed by the image analysis unit 103 is stopped in the playback streaming mode, and in step S915, the analysis data are erased when getting out of the playback streaming mode. Therefore, when the mode once changes from the playback streaming mode to the shooting streaming mode and changes to the playback streaming mode again, then, the processing is executed using only the analysis data accumulated in the shooting streaming mode immediately before.

### Second Embodiment

A second embodiment of the present invention will be hereinafter explained.

In the first embodiment, the analysis processing performed by the image analysis unit 103 is configured to be stopped in the playback streaming mode, but in the second embodiment, a configuration of not stopping the analysis processing will be explained. It should be noted that description about the same portions as those of the first embodiment is omitted, and only the portion characterizing the second embodiment will be explained in details.

<Playback Streaming Mode Processing Flow>

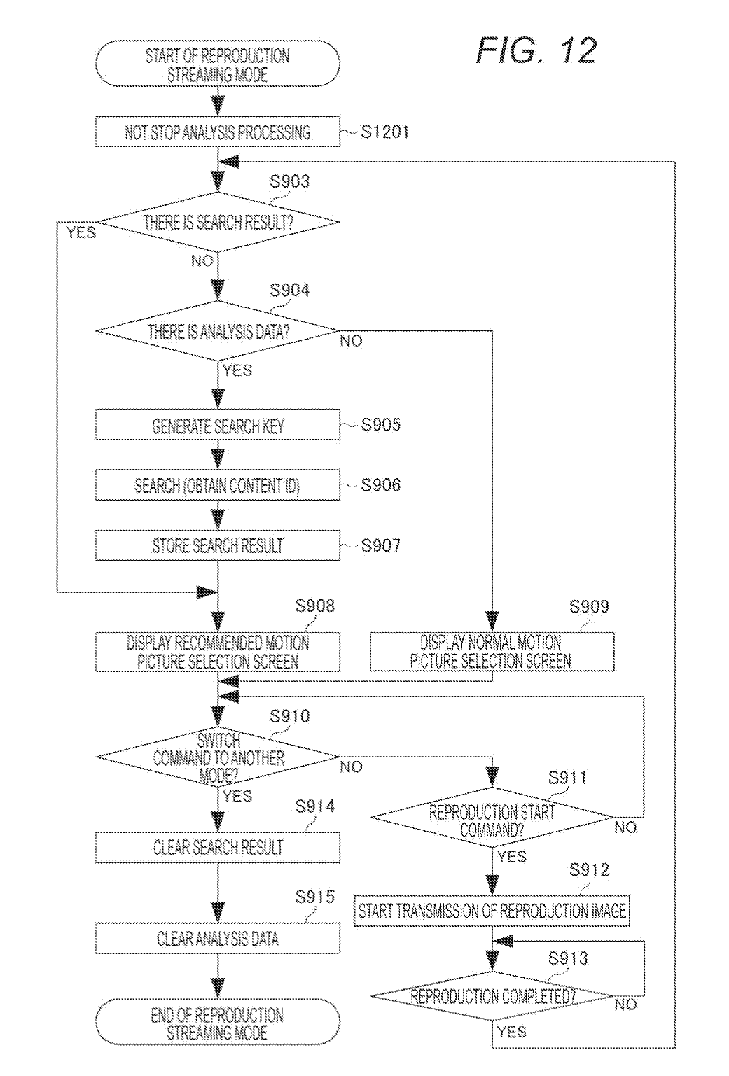

Processing in the playback streaming mode of a camera 100 will be explained in details with reference to FIG. 12.

In step S1201, a control unit 101 does not stop the analysis processing performed by an image analysis unit 103 even when the playback streaming mode is started. This step is a step inserted in order to easily understand the difference from step S901 and step S902 in the first embodiment, but actually, no processing is carried out. Due to this step, the execution of the analysis processing performed by the image analysis unit 103 on the video data received from an image pickup unit 102 is continued even in the playback streaming mode.

Due to the processing executed in step S1201, a flow of processing of search key generation executed in step S905 is different from the first embodiment. In this case, the flow of the search key generation according to the second embodiment is shown in FIG. 10B.

As shown in FIG. 10B, the analysis processing is executed even in the playback streaming mode. Therefore, as a result of search key generation processing at the time of f15 to f16, the search key becomes A, which is a result different from the first embodiment.

The motion picture selection screen displayed in step S908 is also different from the first embodiment. In the second embodiment, both of the search keys generated in the search key generation processing of FIG. 10B are A, and therefore, both of the displayed motion picture selection screens are FIG. 11A.

In the present embodiment, the analysis processing performed by the image analysis unit 103 is not stopped when the playback streaming mode is started. Therefore, in a case where the mode once changes from the playback streaming mode to the shooting streaming mode and changes to the playback streaming mode again, the analysis data accumulated not only in the shooting streaming mode immediately before the current mode but also in the playback streaming mode or the shooting streaming mode before that mode may be the target of the search key generation processing.

### Third Embodiment

A third embodiment according to the present invention will be hereinafter explained.

In the first embodiment, the analysis data generated by the image analysis unit 103 are configured to be erased at the time when the playback streaming mode is terminated. In the third embodiment, a configuration of not erasing analysis data will be explained. It should be noted that description about the same portions as those of the first embodiment is omitted, and only the portion characterizing the third embodiment will be explained in details.

<Playback Streaming Mode Processing Flow>

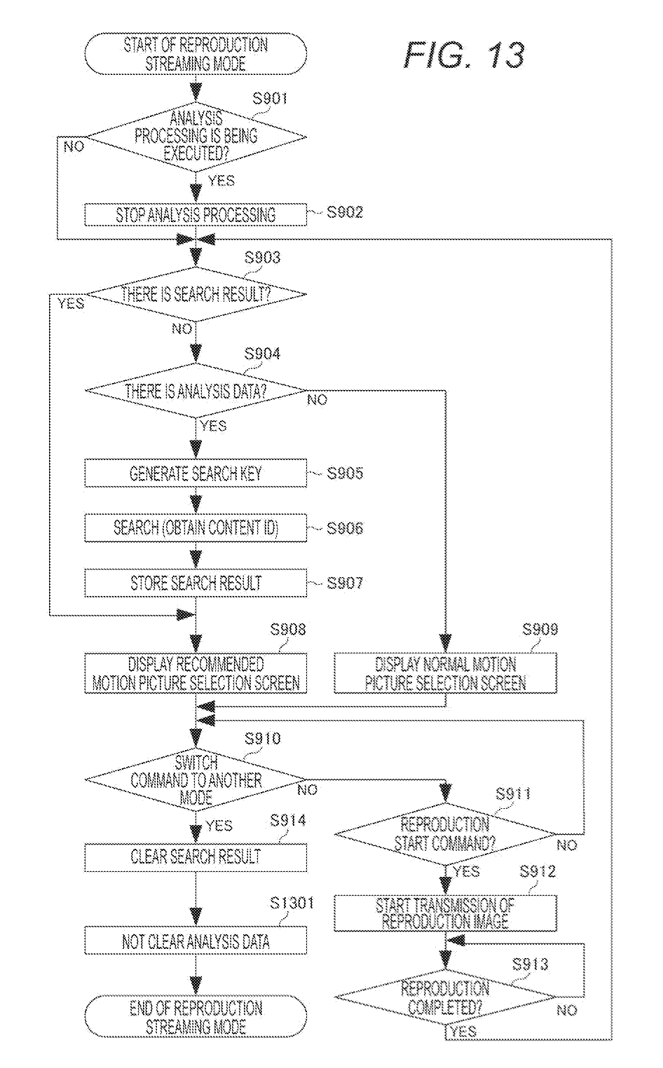

The details of the processing in the playback streaming mode of a camera 100 will be explained with reference to FIG. 13.

In step S1301, a control unit 101 does not erase the analysis data stored in a predetermined area on RAM 106. This step is a step inserted in order to easily understand the difference from step S915 in the first embodiment, but actually, no processing is carried out. Due to this step, the analysis data are not erased when getting out of the playback streaming mode.

Due to the processing executed in step S1301, a flow of processing of search key generation executed in step S905 is different from the first embodiment. In this case, the flow of the search key generation according to the third embodiment is shown in FIG. 10C.

As shown in FIG. 10C, the frames f5, f6 are included in the target of the search key generation processing in the time from f15 to f16. Therefore, as a result of search key generation processing in the time from f15 to f16, the search key becomes A, which is a result different from the first embodiment.

The motion picture selection screen displayed in step S908 is also different from the first embodiment. In the third embodiment, both of the search keys generated in the search key generation processing of FIG. 10C are A, and therefore, both of the displayed motion picture selection screens are FIG. 11A.

In the present embodiment, the analysis data generated by an image analysis unit 103 are not erased when the playback streaming mode is finished. Therefore, in a case where the mode once changes from the playback streaming mode to the shooting streaming mode and changes to the playback streaming mode again, the analysis data accumulated not only in the shooting streaming mode immediately before the current mode but also in the shooting streaming mode before that mode may be the target of the search key generation processing.

### Fourth Embodiment

A fourth embodiment according to the present invention will be hereinafter explained.

In the first embodiment, the processing of the search processing in step S906 is processing for executing search processing for searching the content database using the face ID as the search key and obtaining the corresponding content ID and the appearance rate information as a search result. In the fourth embodiment, further, an embodiment will be explained in a case where a search result is determined in view of history information of the playback streaming transmission. It should be noted that description about the same portions as those of the first embodiment is omitted, and only the portion characterizing the fourth embodiment will be explained in details.

<Playback Streaming Mode Processing Flow>

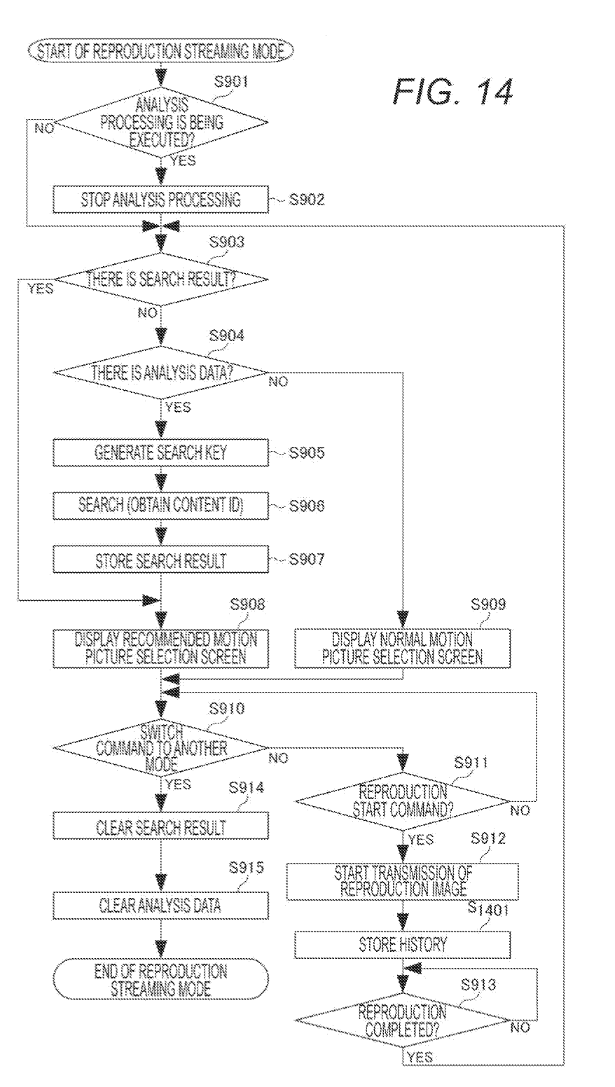

The details of the processing in the playback streaming mode of a camera 100 will be explained with reference to FIG. 14.

After the transmission of the playback image is started in step S912, a control unit 101 stores a transmission history to the content database in step S1401. The transmission history is stored for each external device of transmission destination, and the transmission history information includes identifier information about video data, execution date and time, and the like. In this case, the function for storing the transmission history corresponds to playback streaming history means according to the present invention.

In this case, FIG. 5B illustrates an example of content database according to the fourth embodiment. As shown in FIG. 5B, in the first embodiment, the field of the playback streaming history is added to the content database as shown in FIG. 10A. In FIG. 5B, “X”, “Y”, “Z” indicate identifiers of external devices of transmission destinations, and this indicates that there is a history showing that corresponding content indicated as “REPRODUCED” is played back as streaming. In the explanation about the fourth embodiment, the identifier of a PC 200 is “Y”.

Due to the processing executed in step S1401, the result of the search processing executed in step S906 is different from the first embodiment.

The result searched from the content database as shown in FIG. 5B using the search key A generated in the time from f6 to f7 in FIG. 10A is as follows:

### 00008.MP4 (90%), 00001.MP4 (75%), 00003.MP4 (70%), 00002.MP4 (60%), 00005.MP4 (50%), and 00009.MP4 (10%).

Further, by setting a limitation to those without any playback streaming history of “Y”, the ultimate search result is as follows:

### 00001.MP4 (75%), 00002.MP4 (60%), 00005.MP4 (50%), and 00009.MP4 (10%).

FIG. 11C shows an example of motion picture selection screen displayed in step S908 on the basis of this search result. FIG. 11C is a content different from FIG. 11A.

As described above, in the present embodiment, the processing in the playback streaming mode explained with reference to FIG. 14 is carried out. Accordingly, in a case where switching instruction from the shooting streaming mode to the streaming of the playback streaming recorded motion picture is given, recorded motion pictures related to the same subject as the subject of the shooting streaming can be displayed with a higher degree of precedence on the basis of the analysis result of the captured video, and the motion picture selection screen can be generated, in which recorded motion pictures that have not yet played back by the transmission destination device are displayed with a higher degree of precedence.

### Fifth Embodiment

A fifth embodiment of the present invention will be hereinafter explained.

In the first embodiment, the selection screen of recorded motion pictures to be played back is configured to be displayed in step S908 and step S909, and the device is configured to wait for user's instruction in step S910 and step S911. In the fifth embodiment, a configuration for automatically executing processing without letting a user to give an instruction will be explained. It should be noted that description about the same portions as those of the first embodiment is omitted, and only the portion characterizing the fifth embodiment will be explained in details.

<Playback Streaming Mode Processing Flow>

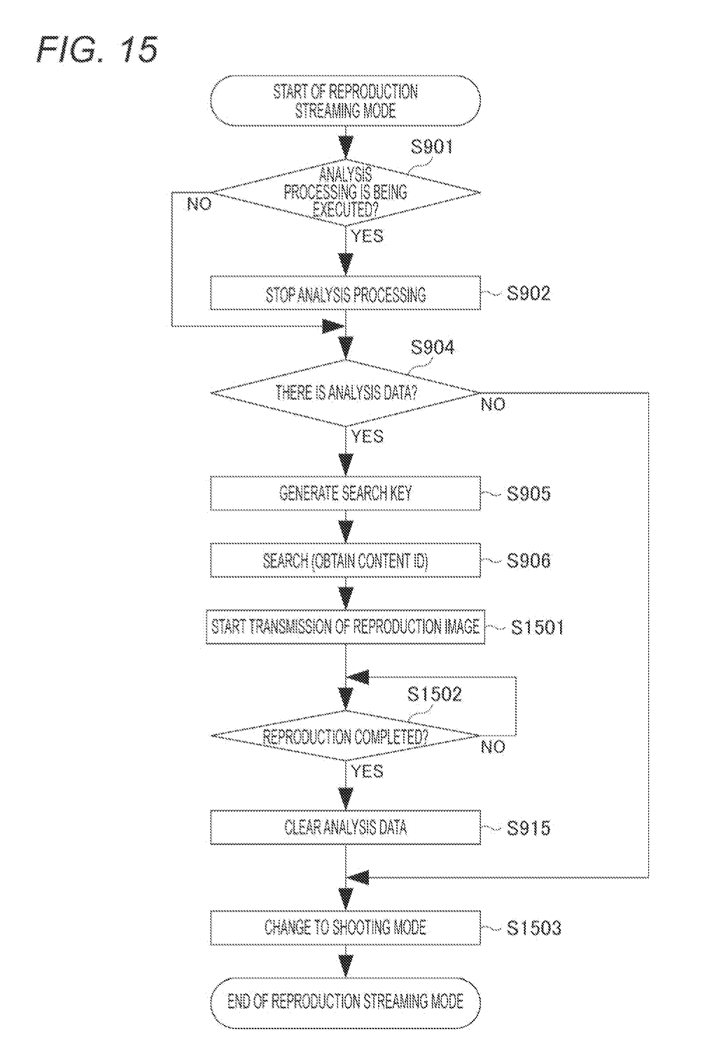

The details of processing in the playback streaming mode of a camera 100 will be explained with reference to FIG. 15. This processing is started when a switching instruction for switching from the shooting streaming mode to the playback streaming mode is given with an operation unit 105. An instruction related to the start of playback streaming transmission is given in synchronization with switching from the shooting mode to the playback mode.

In step S1501, a control unit 101 controls a recording unit 107 to read a recorded motion picture corresponding to a content ID of which appearance rate is the highest from the search result of step S906. Then, the control unit 101 controls a display reproduction unit 104 to execute the playback processing, and controls a communication unit 110 to start streaming transmission of the playback image.

In step S1502, the control unit 101 determines whether the execution of the playback of the content started in step S1501 has been finished or not. The finish of the content playback is determined according to whether the user gave an instruction for termination with the operation unit 105, or whether the playback of the content to the end of the content is completed or not. When the control unit 101 determines that the playback of the content has been finished, subsequently step S915 is performed. When the control unit 101 does not determine that the playback of the content has been finished, the control unit 101 goes into waiting state.

In step S1503, the control unit 101 switches the operation mode from the playback streaming mode to the shooting streaming mode.

As described above, in the present embodiment, the processing in the playback streaming mode explained with reference to FIG. 15 is carried out. Accordingly, in a case where switching instruction from the shooting streaming mode to the streaming of the playback streaming recorded motion picture is given, playback streaming of the recorded motion picture related to the subject of the shooting streaming can be automatically started. When the playback is finished, the mode can be automatically returned back to the shooting streaming mode.

### OTHER EMBODIMENTS

Various embodiments according to the present invention have been hereinabove explained. But the present invention is not limited to these embodiments, and can be modified and changed in various manners within the scope of the gist of the invention.

The present invention is also achieved by executing the following processing. More specifically, software (computer program) achieving the functions of the above embodiments is provided to a system or a device via a network or various kinds of computer-readable recording media. Then, a computer (or a CPU, an MPU, or the like) of the system or the device reads the program and executes the program.

According to the present invention, when the user gives a switching instruction to streaming of a recorded motion picture, the user can easily select a recorded motion picture which is to be streamed and transmitted.

### OTHER EMBODIMENTS

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-022555, filed Feb. 7, 2014, which is hereby incorporated by reference herein in its entirety.

What is claimed is:

1. A communication device comprising:
an image pickup unit;
a recording unit configured to record image data captured by the image pickup unit to a recording medium;
a connection unit connected to an external device;
a transmission unit including a first function for transmitting the recorded image data to the external device, and a second function for successively transmitting the image data captured by the image pickup unit to the external device; and
an output unit configured to output image data, as a candidate of image data to be transmitted by the first function, chosen from among the recorded image data, based on information about a subject captured by the image pickup unit and information about the external device, in a case where an instruction for executing the first function is received while the transmission unit is executing the second function.

2. The communication device according to claim 1,
wherein the recording unit records, to the recording medium, information for distinguishing image data having been transmitted the second function from other image data, and
the output unit outputs, as a candidate of image data to be transmitted by the first function, image data chosen from among the recorded image data based on information about the subject captured by the image pickup unit, information about the external device, and information held by a holding unit.

3. The communication device according to claim 2,
wherein the output unit outputs, as a candidate of image data to be transmitted by the first function, image data not having been transmitted by the second function chosen from among the recorded image data.

4. The communication device according to claim 1, further comprising:
an analysis unit configured to analyze image data successively obtained by being captured by the image pickup unit, thus successively generating information about the subject;
a holding unit configured to successively hold information about the subject generated by the analysis unit; and
an output unit configured to output image data, as a candidate of image data to be transmitted by the first function, chosen from among the recorded image data, based on information about the subject held by the holding unit from a certain period of time before the instruction is received to when the instruction is received and information about the external device, in a case where an instruction for executing the first function is received while the transmission unit is executing the second function.

5. The communication device according to claim 4,
wherein when the first function is started, analysis processing performed by the analysis unit is stopped.

6. The communication device according to claim 5,
wherein when analysis processing performed by the analysis unit is stopped, already accumulated analysis information is invalidated.

7. A control method of a communication device comprising:
an image pickup step;
a recording step for recording image data captured in the image pickup step to a recording medium;
a connection step for connecting to an external device;
a transmission step including a first function for transmitting the recorded image data to the external device, and a second function for successively transmitting the image data captured in the image pickup step to the external device; and
an output step for outputting image data, as a candidate of image data to be transmitted by the first function, chosen from among the recorded image data, based on information about a subject captured in the image pickup step and information about the external device, in a case where an instruction for executing the first function is received while the second function is executed in the transmission step.

8. The control method according to claim 7,
wherein the recording step records, to the recording medium, information for distinguishing image data having been transmitted the second function from other image data, and
the output step outputs, as a candidate of image data to be transmitted by the first function, image data chosen from among the recorded image data based on information about the subject captured by the image pickup step, information about the external device, and information held by a holding step.

9. The control method according to claim 8,
wherein the output step outputs, as a candidate of image data to be transmitted by the first function, image data not having been transmitted by the second function chosen from among the recorded image data.

10. The control method according to claim 7, further comprising:
an analysis step for analyzing image data successively obtained by being captured by the image pickup step, thus successively generating information about the subject;
a holding step for successively holding information about the subject generated by the analysis step; and
an output step for outputting image data, as a candidate of image data to be transmitted by the first function, chosen from among the recorded image data, based on information about the subject held by the holding step from a certain period of time before the instruction is received to when the instruction is received and information about the external device, in a case where an instruction for executing the first function is received while the transmission step is executing the second function.

11. The control method according to claim 10,
wherein when the first function is started, analysis processing performed by the analysis step is stopped.

12. The control method according to claim 11,
wherein when analysis processing performed by the analysis step is stopped, already accumulated analysis information is invalidated.
